(19) United States
(12) Patent Application Publication
(10) Pub. No.: US 2005/0045202 A1
(43) Pub. Date: Mar. 3, 2005

(54) Method for wafer surface cleaning using hydroxyl radicals in deionized water

(76) Inventor: Chih-Yuan Huang, Hsinchu (TW)

Correspondence Address: RABIN & BERDO, P.C., Suite 500, 1101 14th Street, N.W., Washington, DC, 20005, US

(21) Appl. No.: 10/882,254

(22) Filed: Jul. 2, 2004

(30) Foreign Application Priority Data
Sep. 1, 2003 (TW) 092124150

(51) Int. Cl. B08B 3/00

(52) U.S. Cl. 134/2; 134/26

(57) ABSTRACT

In a method for wafer surface cleaning using hydroxyl radicals in deionized water prior to a growth of gate oxide or tunneling oxide in a semiconductor process, DI water containing hydroxyl radicals is applied to the wafer surface to remove the contaminants therefrom, specifically for metallic particles, in association with a chemical solution process applied to the wafer surface prior thereto or thereafter, and preferably, another application of DI water containing hydroxyl radicals to the wafer surface is practiced with the chemical solution process between the two steps of application of DI water containing hydroxyl radicals to the wafer surface.

### FIELD OF THE INVENTION

The present invention relates generally to a semiconductor process and more particularly, to a method for wafer surface cleaning using hydroxyl radicals in deionized water (DI water).

### BACKGROUND OF THE INVENTION

In semiconductor processes, the shrinking of integrated circuits (IC) and the microdevices thereof has the wafer contamination more serious that is resulted from contact contaminations of various organics and particles or contaminated by the metallic impurities from the manufacturing equipments that have the particle size larger than or close to that of the microdevice scale. Any such residual contaminants left on the wafer surface during the semiconductor process will result in short circuit or defect among the microdevices of the processed wafer, and thus they are not allowed left on the wafer surface in the semiconductor process. Consequently, removal of contaminants from the wafer surface is crucial to the semiconductor process, among which chemical wet cleaning is the most cost-effective method for wafer productions, and the Rectifier Company America clean (RCA-clean) is the earliest standard process used for wafer surface cleaning.

FIG. 1 shows a typical RCA process in its detailed workflow, which is started from step 1, including applying sulfuric-peroxide mix (SPM) composed of sulfuric acid (H₂SO₄) solution and hydrogen peroxide (H₂O₂) solution to a wafer surface for removal of organics and photoresist from the wafer surface, performing quick dump rinse (QDR) with DI water to the wafer surface, performing DI water rinse to the wafer surface, applying diluted hydrofluoric acid (dHF) solution to the wafer surface for removal of native oxide on the wafer surface, and performing DI water rinse again to the wafer surface. Then in step 2, standard clean 1 (SC-1) solution composed of ammonium hydroxide (NH₄OH) and H₂O₂ is applied to the wafer surface by megasonics (Meg.) to remove contaminant particles from the wafer surface, and the wafer surface is rinsed by DI water. In step 3, SC-2 solution composed of hydrochloric acid (HCl) and H₂O₂ is applied to the wafer surface to remove metal impurities from the wafer surface, then the wafer surface is rinsed by DI water, a Meg. final rinse is applied to the wafer surface again, and at last, the wafer surface is dried.

Briefly, the RCA method includes five primary clean steps and seven rinses, so that the process is time consuming and complicated, and the consumed chemical quantity is huge. Moreover, due to the various chemicals to prepare the various mixed solution and the vaporized consumption of chemical solution, the RCA-clean requires very high cost of ownership (CoO), and furthermore, the chemical waste disposal requires even more expensive process for environmental pollution prevention. To avoid the drawback of the RCA-clean, an alternative method using ozone (O₃) water for wafer surface cleaning is proposed.

FIG. 2 shows the workflow of a typical wafer surface cleaning process by O₃ water, which is a two-step process with an integrated rinse and dry based on the Marangoni process, and is also called Interuniveristy Micro-Electronics Center clean (IMEC-clean). Step 1 is carried out for oxide growth by applying mixture of H₂SO₄ and O₃ solution or O₃ water to the wafer surface so as to remove organics from the wafer surface, step 2 applies dHF solution or combination of dHF and HCl solutions to the wafer surface for oxide removal, by which metal impurities and contaminant particles are removed together with the etched oxide from the wafer surface, and in step 3, re-oxidation is practiced to grow clean chemical oxide on the wafer surface by applying Megasonic O₃ water or O₃ water combined with HCl solution to the wafer surface. Finally, the wafer surface is rinsed with DI water and dried by process including isopropanol vapor (IPA vapor) Marangoni drying process to avoid watermarks formed on the wafer surface. However, the step 3 in this process is not necessary and is sometimes jumped over, since the wafer surface will become hydrophilic once the clean chemical oxide is formed thereon, which enhances the wafer surface dried more quickly during the final drying process.

Because of the strong oxidation ability of O₃ water and its desolation into water and oxygen after rinse, it therefore does not require any further process for chemical waste disposal. However, even the CoO by using O₃ water for the wafer surface cleaning is lower than that by RCA process, it is still expensive. The RCA-clean and IMEC-clean are shown for exemplatory illustration of various types of contaminations removal, and their modifications and variations or any other alternative recipes, depending on the contaminations and the chemicals sensitive thereto, are all disadvantageous to the semiconductor process by high CoO and/or chemical waste disposal.

The contaminants to be removed from the wafer surface in a semiconductor process primarily include metallic particles, organics and native oxide. However, ozone water itself cannot directly remove the metallic contaminants embedded in oxide, and modifications, such as introduction of hydrofluoric acid into the ozone water and alternative applications of diluted hydrofluoric acid solution and ozone water to the wafer surface, are proposed for exposing the metallic contaminants from oxide and removing subsequently. In a flash or nonvolatile memory process, the metallic contamination causes more serious problem to the gate oxide or tunneling oxide in the cell region, compared with the peripheral region. For further simpler clean process, lower CoO, more efficient particle removal, better performance and more friendly to environment, it is desired a method for wafer surface cleaning to substitute for hydrogen peroxide and ozone in the conventional clean processes.

### SUMMARY OF THE INVENTION

An object of the present invention is to provide a method for wafer surface cleaning using hydroxyl radicals in DI water to improve the efficiency of removing contaminant particles from the wafer surface in a semiconductor process.

Another object of the present invention is to provide a method for wafer surface cleaning using hydroxyl radicals in DI water to reduce the CoO therewith.

Prior to a growth of gate oxide or tunneling oxide in a semiconductor process, according to the present invention, a method for wafer surface cleaning using hydroxyl radicals in DI water comprises applying a DI water containing hydroxyl radicals to the wafer surface, in association with a chemical solution process applied to the wafer surface, and the chemical solution process includes SC-1, SC-2, SC-1 and SC-2, HF, or HF/HCl recipe. Preferably, another application of DI water containing hydroxyl radicals to the wafer surface is practiced with the chemical solution process between the two steps of application of DI water containing hydroxyl radicals to the wafer surface. The application of DI water containing hydroxyl radicals to the wafer surface is especially advantageous to metallic particles removal. The wafer surface cleaning method proposed hereof can substitute for hydrogen peroxide and ozone in the conventional processes, but achieve lower CoO compared to ozone process and RCA process, comparable particle removal efficiency compared to ozone clean and better performance than RCA clean. Moreover, the hydroxyl radicals process hereof shows comparable charge-to-breakdown result compared to ozone clean and better than RCA clean.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a typical RCA process in its detailed workflow;

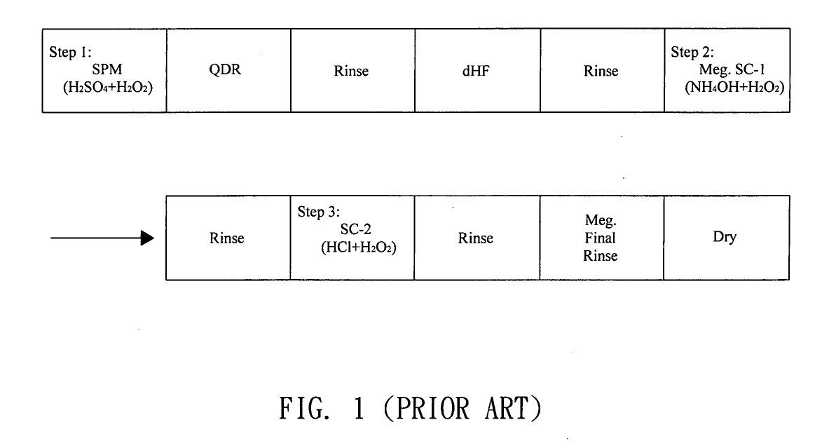

FIG. 2 shows the workflow of a typical wafer surface cleaning process with O₃ water;

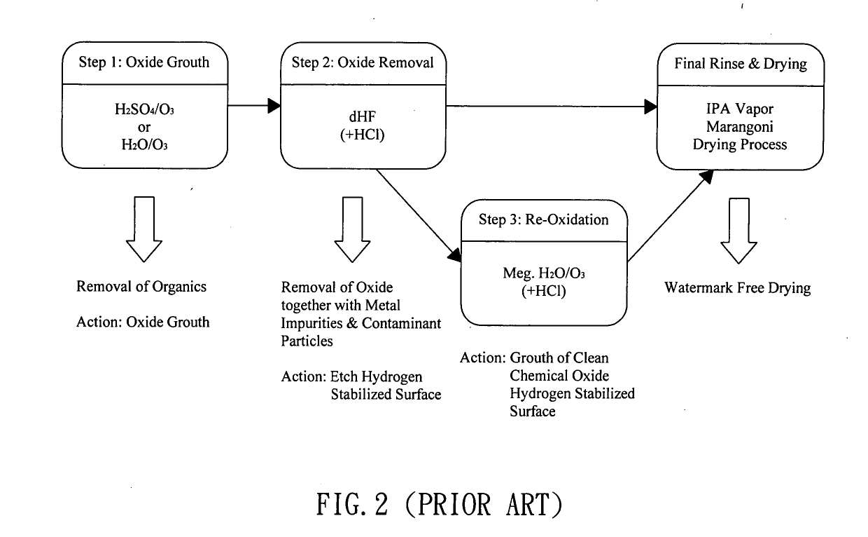

FIG. 3 shows a workflow of an embodiment method according to the present invention;

FIG. 4 shows the oxidation potentials of various oxidants;

FIG. 5 the growth of chemical oxide related to process time resulted from hydroxyl radical (OH*), ozone (O₃) and hydrogen peroxide (H₂O₂) applied to a wafer surface;

FIG. 6 shows the two pathways compete for substrate;

FIG. 7 shows the particle removal comparison among applications of SC-1, hydroxyl radicals and ozone to LPD; and

FIG. 8 shows the charge-to-breakdown Q_{bd} after several wafer surface cleaning processes using various oxidants.

### DETAILED DESCRIPTION OF THE INVENTION

For wafer surface cleaning prior to a growth of gate oxide or tunneling oxide in a semiconductor process, a novel method is proposed in which hydroxyl radicals (OH*) in DI water are used to substitute for O₃ and H₂O₂ in the conventional wafer surface cleaning processes, thereby achieving higher capability on wafer surface cleaning with lower CoO.

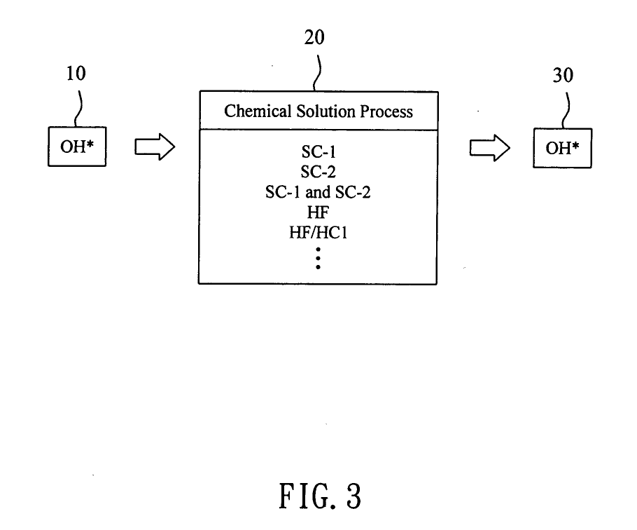

FIG. 3 shows a workflow of an embodiment method according to the present invention that is integrated two steps of application of DI water containing hydroxyl radicals to the wafer surface with a chemical solution process applied to the wafer surface therebetween. In step 10, DI water containing hydroxyl radicals is applied to the wafer surface to remove contaminants from the wafer surface, for which the prepared DI water contains hydroxyl radicals of the concentration ranged from 1 ppm to 30 ppm, the temperature of the DI water is ranged from 20° C. to 50° C., and the wafer surface is rinsed or dipped for longer than 5 seconds for the hydroxyl radicals in the DI water to oxidize the contaminants on the wafer surface, preferably with megasonic enhancement. In the subsequent chemical solution process of step 20, the wafer surface can be applied with one or more of various chemical cleaners, such as SC-1, SC-2, SC-1 and SC-2, HF, and HF/HCl solution, depending on the practice process conditions or the primary contaminants to be removed. Typically, for a flash memory process, the SC-1 solution comprises NH₄OH:H₂O₂:H₂O at 1:1-5:5-100, the SC-2 solution comprises HCl:H₂O₂:H₂O at 1:1-5:5-100, the HF solution comprises HF:H₂O at 1:10-500, and the HF/HCl solution comprises HF:HCl:H₂O at 1:1-10:10-1000. Each time a chemical solution is applied, a rinse to the wafer surface follows thereto. After the chemical solution process 20, DI water containing hydroxyl radicals is applied again to the wafer surface in step 30 for efficiency enhancement, and the conditions for the DI water are similar to that of step 10, i.e., having hydroxyl radicals of 1 ppm to 30 ppm, temperature of from 20° C. to 50° C., rinsing the wafer surface for longer than 5 seconds. However, the step 30 is not a necessary step, and can be saved. Moreover, the clean method can be alternatively performed by the chemical solution process first, and then by the application of DI water containing hydroxyl radicals to the wafer surface in other embodiments.

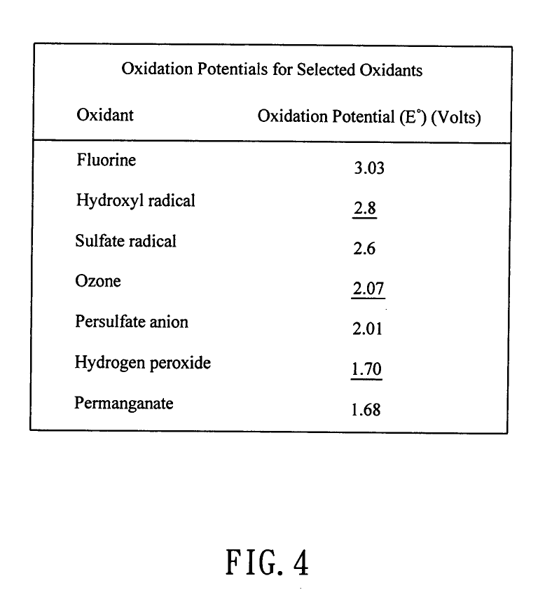

To illustrate the principles of the present invention and the clean effect it achieved, FIG. 4 shows the oxidation potentials of various oxidants, from which it is shown that the oxidation potentials of hydroxyl radical (OH*), ozone (O₃) and hydrogen peroxide (H₂O₂) are 2.8, 2.07 and 1.70, respectively, and all of them are strong oxidants. It is thus obvious that the oxidation ability of hydroxyl radical is higher than those of O₃ and H₂O₂, since the oxidation potential of hydroxyl radical is much higher than those of ozone and hydrogen peroxide. Consequently, it is evidenced that hydroxyl radicals in DI water can be used to substitute for O₃ and H₂O₂ for wafer surface cleaning in semiconductor processes and by which even higher capability on wafer surface cleaning is achieved.

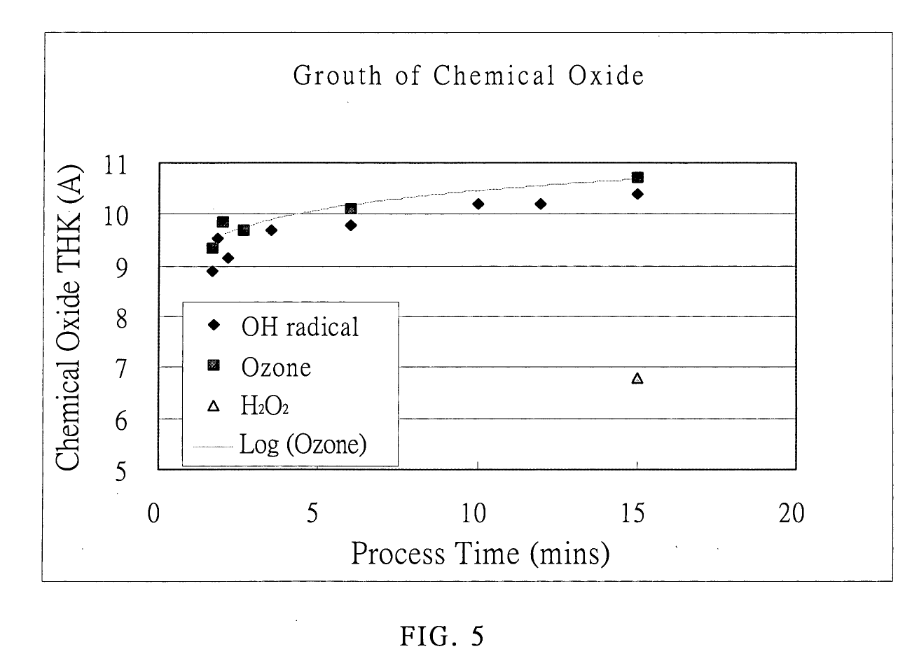

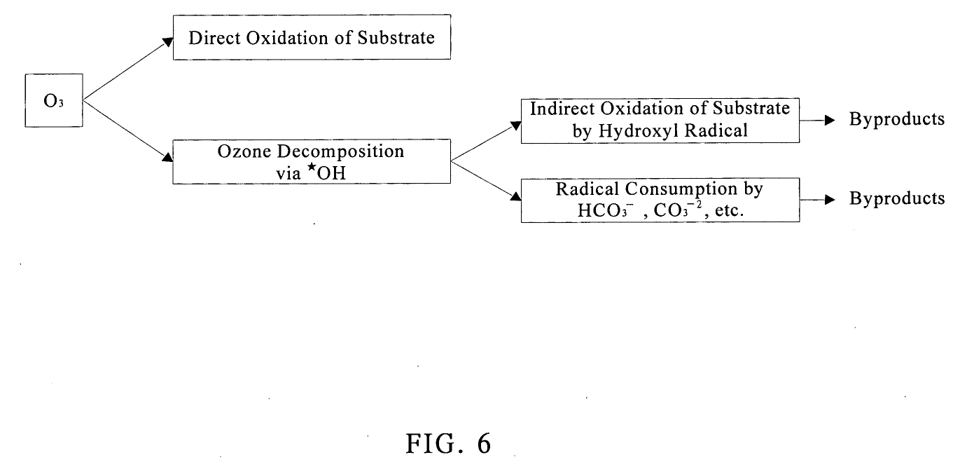

Another evidence is provided in FIG. 5, which diagram shows the growth of chemical oxide related to process time resulted from hydroxyl radical (OH*), ozone (O₃) and hydrogen peroxide (H₂O₂) applied to a wafer surface. From the data, the chemical oxide growth rates of hydroxyl radical and ozone are close to each other, whereas the chemical oxide growth rate of hydroxyl radical is far faster than that of hydrogen peroxide, and it is thus evidenced that, when applied to silicon substrate, the oxidation ability of hydroxyl radicals in DI water with silicon substrate according to the present invention is nearly the same as that of ozone water in the conventional IMEC-clean, but is much higher than that of hydrogen peroxide in the conventional RCA-clean. Therefore, the wafer surface cleaning method using hydroxyl radicals in DI water will have almost the same efficiency of removing particles as that of the conventional IMEC-clean using ozone, but higher than that of the conventional RCA-clean using hydrogen peroxide. However, the ozone application is suitable in acidic solutions, while the hydroxyl radicals can perform in basic solutions with better advantage of particle removal efficiency. FIG. 6 shows the two pathways compete for substrate, i.e., compounds to oxidize, of which the direct oxidation with aqueous ozone is relatively slow, compared to hydroxyl free radical oxidation, but the concentration of aqueous ozone is relatively high. On the other hand, the hydroxyl radical reaction is fast, but the concentration of hydroxyl radicals under normal ozonation conditions is relatively small. It has been found that under acidic conditions, the direct oxidation with molecular ozone is of primary importance, and under conditions favoring hydroxyl free radical production such as high pH and exposure to UV light, the hydroxyl oxidation starts to dominate.

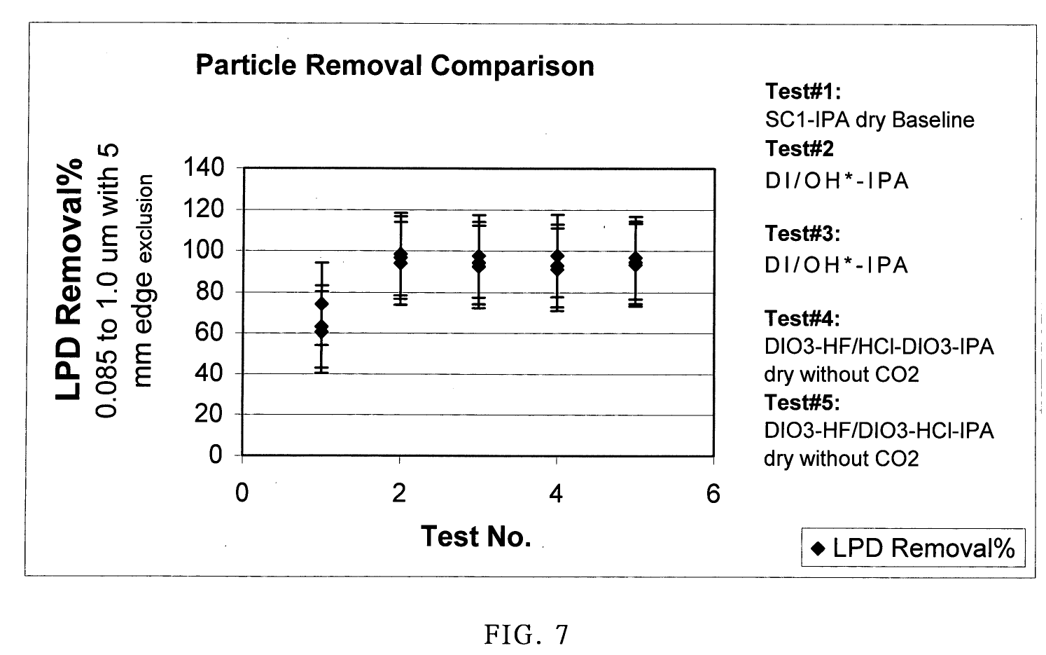

FIG. 7 further provides a real test result for the particle removal comparison applied to liquid phase deposition (LPD), showing that the hydroxyl radicals process has comparable particle removal efficiency compared to the ozone clean and better performance to the SC-1 clean.

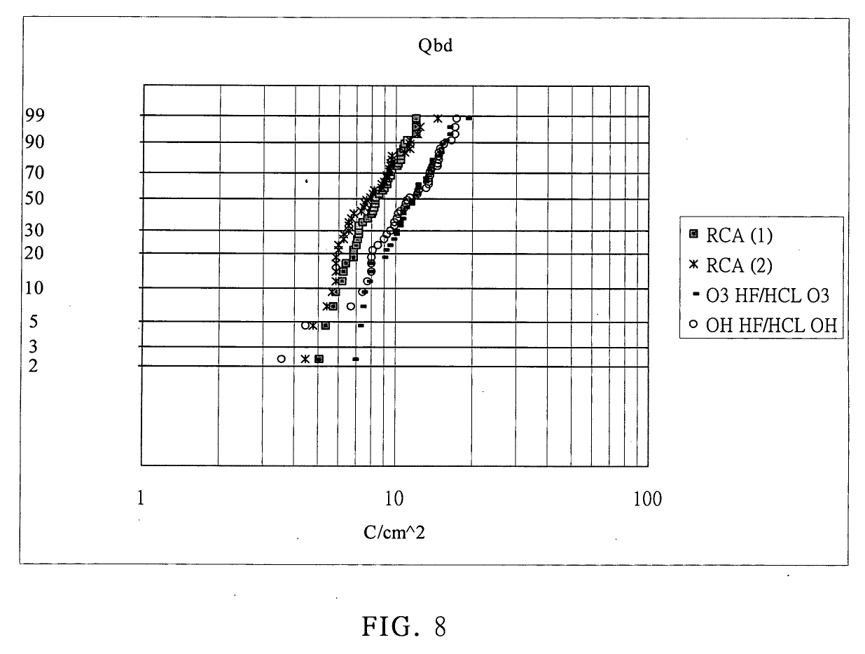

The test of charge-to-breakdown Q_{bd} is a direct method to observe the clean performance of a wafer surface, and FIG. 8 shows the electric parameter Q_{bd} after several wafer surface cleaning processes using various oxidants, from which the charge-to-breakdown of a processed wafer after the wafer surface cleaning using hydroxyl radicals in DI water according to the present invention is close to that of the conventional IMEC-clean using ozone (O₃) water, but is more excellent than that of the conventional RCA-clean using hydrogen peroxide (H₂O₂).

It has been shown that the hydroxyl radicals can clean wafer surface and substitute for ozone and hydrogen peroxide in the conventional clean methods. For the cost of preparing DI water containing hydroxyl radicals lower than those of preparing solution containing O₃ and H₂O₂, the CoO is thus reduced when the present invention is applied for wafer surface cleaning. Moreover, higher capability of removing contaminations from the wafer surface is obtained when the present invention is applied in semiconductor process than those of the conventional IMEC-clean using O₃ water and the conventional RCA-clean using H₂O₂.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A method for wafer surface cleaning using hydroxyl radicals in deionized water prior to a growth of gate oxide or tunneling oxide in a semiconductor process, the method comprising the steps of:
applying a DI water containing hydroxyl radicals to the wafer surface; and
a chemical solution process applied to the wafer surface.

2. The method of claim 1, wherein the DI water contains the hydroxyl radicals of a concentration ranged from 1 ppm to 30 ppm.

3. The method of claim 1, wherein the DI water has a temperature ranged from 20° C. to 50° C.

4. The method of claim 1, wherein the DI water is applied to the wafer surface for a time period longer than 5 seconds.

5. The method of claim 1, wherein the DI water is megasonically applied to the wafer surface.

6. The method of claim 1, further comprising applying a second DI water containing hydroxyl radicals to the wafer surface after the chemical solution process.

7. The method of claim 1, wherein the second DI water contains the hydroxyl radicals of a concentration ranged from 1 ppm to 30 ppm.

8. The method of claim 1, wherein the second DI water has a temperature ranged from 20° C. to 50° C.

9. The method of claim 1, wherein the second DI water is applied to the wafer surface for a time period longer than 5 seconds.

10. The method of claim 1, wherein the second DI water is megasonically applied to the wafer surface.

11. The method of claim 1, wherein the chemical solution process comprises the steps of:
applying an SC-1 solution to the wafer surface; and
rinsing the wafer surface.

12. The method of claim 11, wherein the SC-1 solution comprises NH₄OH:H₂O₂:H₂O at 1:1-5:5-100.

13. The method of claim 1, wherein the chemical solution process comprises the steps of:
applying an SC-2 solution to the wafer surface; and
rinsing the wafer surface.

14. The method of claim 13, wherein the SC-2 solution comprises HCl:H₂O₂:H₂O at 1:1-5:5-100.

15. The method of claim 1, wherein the chemical solution process comprises the steps of:
applying an SC-1 solution to the wafer surface;
rinsing the wafer surface;
applying an SC-2 solution to the wafer surface; and
rinsing the wafer surface.

16. The method of claim 15, wherein the SC-1 solution comprises NH₄OH:H₂O₂:H₂O at 1:1-5:5-100.

17. The method of claim 15, wherein the SC-2 solution comprises HCl:H₂O₂:H₂O at 1:1-5:5-100.

18. The method of claim 1, wherein the chemical solution process comprises the steps of:
applying an HF solution to the wafer surface; and
rinsing the wafer surface.

19. The method of claim 18, wherein the HF solution comprises HF:H₂O at 1:10-500.

20. The method of claim 1, wherein the chemical solution process comprises the steps of:
applying an HF/HCl solution to the wafer surface; and
rinsing the wafer surface.

21. The method of claim 20, wherein the HF/HCl solution comprises HF:HCl:H₂O at 1:1-10:10-1000.

22. A method for wafer surface cleaning using hydroxyl radicals in deionized water prior to a growth of gate oxide or tunneling oxide in a semiconductor process, the method comprising the steps of:
a chemical solution process applied to the wafer surface; and
applying a DI water containing hydroxyl radicals to the wafer surface.

23. The method of claim 22, wherein the DI water contains the hydroxyl radicals of a concentration ranged from 1 ppm to 30 ppm.

24. The method of claim 22, wherein the DI water has a temperature ranged from 20° C. to 50° C.

25. The method of claim 22, wherein the DI water is applied to the wafer surface for a time period longer than 5 seconds.

26. The method of claim 22, wherein the DI water is megasonically applied to the wafer surface.

27. The method of claim 22, wherein the chemical solution process comprises the steps of:
applying an SC-1 solution to the wafer surface; and
rinsing the wafer surface.

28. The method of claim 27, wherein the SC-1 solution comprises NH₄OH:H₂O₂:H₂O at 1:1-5:5-100.

29. The method of claim 22, wherein the chemical solution process comprises the steps of:
applying an SC-2 solution to the wafer surface; and
rinsing the wafer surface.

30. The method of claim 29, wherein the SC-2 solution comprises HCl:H₂O₂:H₂O at 1:1-5:5-100.

31. The method of claim 22, wherein the chemical solution process comprises the steps of:
applying an SC-1 solution to the wafer surface;
rinsing the wafer surface;
applying an SC-2 solution to the wafer surface; and
rinsing the wafer surface.

32. The method of claim 31, wherein the SC-1 solution comprises NH₄OH:H₂O₂:H₂O at 1:1-5:5-100.

33. The method of claim 31, wherein the SC-2 solution comprises HCl:H₂O₂:H₂O at 1:1-5:5-100.

34. The method of claim 22, wherein the chemical solution process comprises the steps of:
applying an HF solution to the wafer surface; and
rinsing the wafer surface.

35. The method of claim 34, wherein the HF solution comprises HF:H₂O at 1:10-500.

36. The method of claim 22, wherein the chemical solution process comprises the steps of: applying an HF/HCl solution to the wafer surface; and rinsing the wafer surface.

37. The method of claim 36, wherein the HF/HCl solution comprises HF:HCl:H₂O at 1:1-10:10-1000.
